(19) United States
(12) Patent Application Publication
(10) Pub. No.: US 2013/0083169 A1
(43) Pub. Date: Apr. 4, 2013

(54) IMAGE CAPTURING APPARATUS, IMAGE PROCESSING APPARATUS, IMAGE PROCESSING METHOD AND PROGRAM

(71) Applicant: Shugo Higuchi, Inagi-shi (JP)

(72) Inventor: Shugo Higuchi, Inagi-shi (JP)

(73) Assignee: CANON KABUSHIKI KAISHA, Tokyo (JP)

(21) Appl. No.: 13/613,776

(22) Filed: Sep. 13, 2012

(30) Foreign Application Priority Data
Oct. 3, 2011 (JP) 2011-219388
Jul. 19, 2012 (JP) 2012-160689

(51) Int. Cl. H04N 13/02

(52) U.S. Cl. 348/47; 348/E13.074

(57) ABSTRACT

Information for a camera unit not used for a stereoscopic view in the case of a display method having parallax only in a horizontal direction is used to thereby generate a multi-viewpoint image subjected to an image processing. Step S801 acquires parallax-related information to be displayed. Step S802 determines, based on the parallax-related information, whether the parallax direction is “only the horizontal direction” or not. When the parallax direction is “only the horizontal direction”, the processing proceeds to Step S803. When the parallax direction is not “only the horizontal direction”, the processing proceeds to Step S807. Step S803 acquires the layout information for the image capturing units. Next, Step S804 selects the image capturing unit in the vertical direction. Next, Step S805 uses the selected image to perform a high dynamic range (HDR) combination.

### BACKGROUND OF THE INVENTION

1. Field of the Invention

The present invention relates to an image capturing apparatus, an image processing apparatus, image processing method and program. In particular, the present invention relates to an image capturing apparatus, an image processing apparatus, and the method thereof using a multi-viewpoint image capturing apparatus constituted by a plurality of image capturing units at least arranged in a two-dimensional manner.

2. Description of the Related Art

Conventionally, a display apparatus has been known that uses an image obtained by capturing an imaging object from a plurality of points of view (hereinafter referred to as a multi-viewpoint image) to obtain the stereoscopic view of the object. Generally, a multi-viewpoint image can be acquired by various image capturing methods. A multi-viewpoint image also can be acquired by a multiview image capturing apparatus or a plenoptic image capturing apparatus in recent years. The multiview image capturing apparatus includes a plurality of image capturing modules by which multi-viewpoint images can be acquired simultaneously (see Japanese Patent Laid-Open No. 2011-109484). The plenoptic image capturing apparatus is also configured so that a micro lens array can be provided in front of an image sensor to thereby to record light from multiple directions. As a result, a multiview image can be generated by an image processing.

Various display methods have been known for a display apparatus that provides a stereoscopic view. Such display methods can be classified, depending on a parallax direction, to a direction that has parallax only in a horizontal direction (horizontal parallax) and a direction that has parallax (horizontal/vertical parallax) both in a horizontal direction and a vertical direction. The horizontal parallax display method includes, for example, a parallax barrier method according to which a vertical slit is provided in front of a display surface and a lenticular method using a lenticular lens. The horizontal/vertical parallax display method includes, for example, a lens array method according to which a two-dimensional lens array is provided in front of a display surface and a computer graphics (CG) method to detect a position of a point of view to thereby generate images of left and light point of views.

Generally, in the case of a display method that has parallax only in a horizontal direction, there is no need to use a multi-viewpoint image having parallax in a vertical direction. However, in the case of a multiview image capturing apparatus as disclosed in Japanese Patent Laid-Open No. 2011-109484 in which a plurality of camera units are arranged in a two-dimensional manner, a disadvantage is caused in that information for a camera unit arranged in an unnecessary vertical direction is also processed.

In view of the above, it is an objective of the present invention to generate such a multi-viewpoint image that is subjected to an image processing using information for a camera unit unnecessary to obtain a stereoscopic view by a display method having parallax only in a horizontal direction.

### SUMMARY OF THE INVENTION

An image capturing apparatus of the present invention is an image capturing apparatus that generates parallax image data representing a plurality of parallax images having parallax in a first direction and characterized by including an input unit configured to receive a plurality of input image data acquired by a plurality of image capturing units arranged on a lattice consisting of the first direction and a second direction different from the first direction and a generation unit configured to combine, with regard to each column of the second direction, a plurality of input image data obtained by an image capturing unit corresponding to the column to thereby generate parallax image data representing a plurality of parallax images having parallax in the first direction.

According to the present invention, in a multi-viewpoint image capturing apparatus configured by a plurality of camera units arranged in a two-dimensional manner, image capturing conditions can be changed based on layout information to thereby effectively use information for a camera unit not used for a stereoscopic view. Furthermore, a multi-viewpoint image having a wide dynamic range and a multi-viewpoint image having a reduced noise amount can be acquired.

Further features of the present invention will become apparent from the following description of exemplary embodiments (with reference to the attached drawings).

### BRIEF DESCRIPTION OF THE DRAWINGS

FIG. 1 illustrates one example of a multi-viewpoint image capturing apparatus including a plurality of image capturing units according to one embodiment of the present invention;

FIG. 2 is a block diagram illustrating one example of the internal configuration of a multi-viewpoint image capturing apparatus;

FIG. 3 illustrates one example of the internal configuration of the image capturing unit;

FIG. 4 is a flowchart illustrating the operation of an image capturing control unit in Embodiment 1;

FIG. 5 illustrates one example of a display unit for inputting parallax-related information;

FIG. 6 illustrates one example of the layout information of the image capturing unit;

FIG. 7 illustrates one example of the change amount of the image capturing condition based on the layout information;

FIG. 8 is a flowchart illustrating the operation of an image processing unit in Embodiment 1;

FIG. 9 is a conceptual diagram illustrating an HDR combination processing of this embodiment;

FIG. 10 illustrates the flowchart of the operation of the image capturing control unit in Embodiment 2 of the present invention;

FIG. 11 illustrates the flowchart illustrating the operation of the image processing unit in Embodiment 2 of the present invention;

FIG. 12 is a conceptual diagram illustrating the NR processing of this embodiment;

FIG. 13 illustrates one example of a change amount of the image capturing condition based on the layout information;

FIG. 14 illustrates the flowchart illustrating the operation of the image processing unit in Embodiment 3 of the present invention;

FIG. 15 illustrates the flowchart illustrating the operation of a distance map calculation processing of this embodiment;

FIG. 16 is a conceptual diagram illustrating the relation in this embodiment between a horizontal image capturing position and an object;

FIG. 17 is a flowchart illustrating the operation of the HDR combination processing of this embodiment;

FIG. 18 is a conceptual diagram illustrating the relation in this embodiment between a vertical image capturing position and an object;

FIG. 19 is a flowchart illustrating a processing for changing a point of view of this embodiment; and

FIG. 20 is a conceptual diagram illustrating the relation in this embodiment between a horizontal position of the point of view and an object.

### DESCRIPTION OF THE EMBODIMENTS

### Embodiment 1

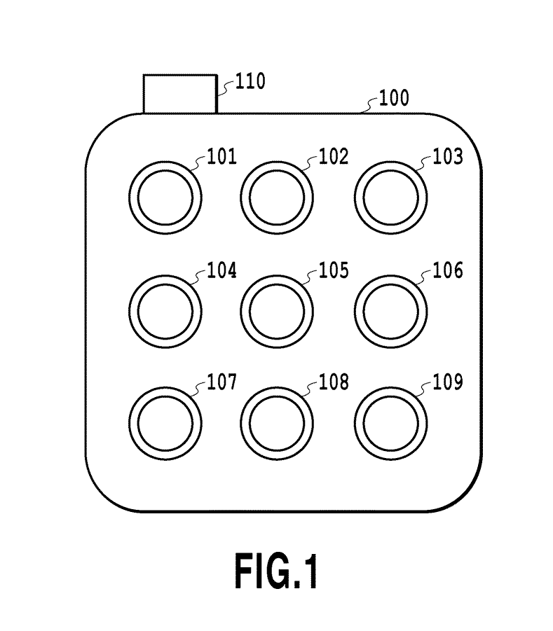

FIG. 1 illustrates one example of a multi-viewpoint image capturing apparatus according to a multiview method including a plurality of image capturing units. The image capturing apparatus includes a housing 100. The housing 100 includes nine image capturing units 101 to 109 for acquiring a color image and an image capturing button 110. As shown in FIG. 1, the nine image capturing units are uniformly arranged in a two-dimensional manner. When a user depresses the image capturing button 110, the image capturing units 101 to 109 use sensors (image sensor) to receive the optical information for an object. Then, the received signal is subjected to an A/D conversion. At the same time, a plurality of color image data (digital data) are acquired.

By the multiview image capturing apparatus as described above, a group of color images obtained by imaging one object from a plurality of point of views can be obtained. In the following description, the number of image capturing units is set to nine. However, the number of the image capturing units is not limited to this. Any number can be used so long as the image capturing apparatus has a plurality of image capturing units.

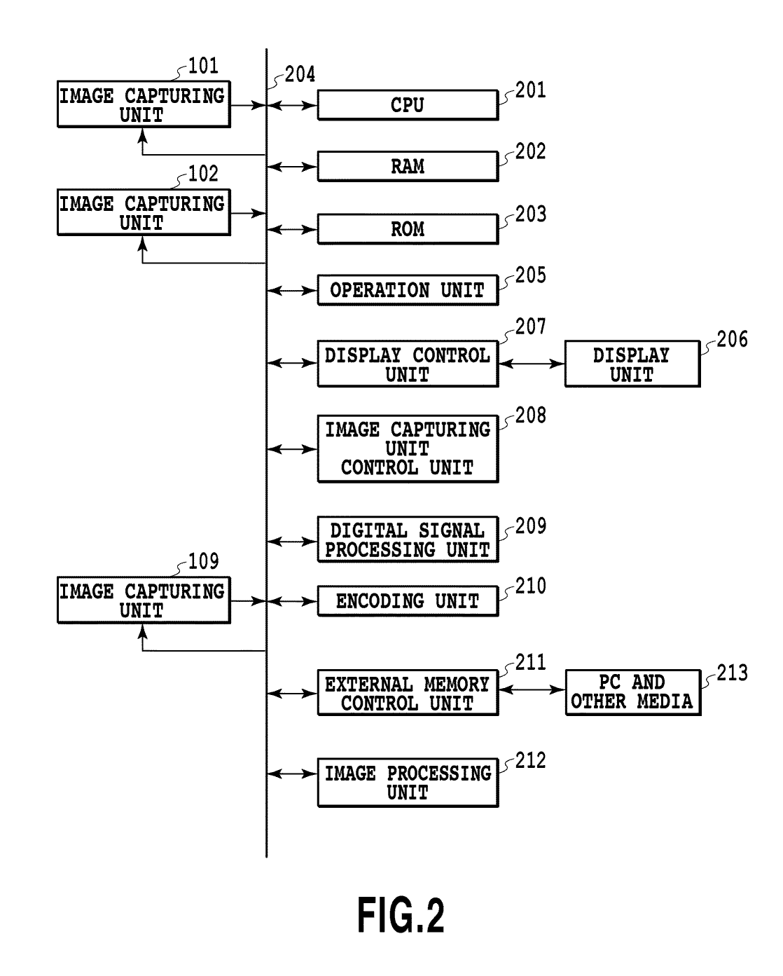

FIG. 2 is a block diagram illustrating the internal configuration of the image capturing apparatus 100. A center processing apparatus (CPU) 201 controls the respective units described below in an integrated manner. A RAM 202 functions as the main memory and the work area of the CPU 201 for example. The ROM 203 stores therein control programs executed by the CPU 201 for example.

A bus 204 functions as a path for transferring various pieces of data. For example, the digital data acquired by the image capturing units 101 to 109 is sent via this bus 204 to a predetermined processing unit. An operation unit 205 receives an instruction from the user. Specifically, the operation unit 205 includes a button or a mode dial for example. A display unit 206 displays a captured image or a character for example. The display unit 206 may be a liquid display for example. The display unit 206 may have a touch screen function. In this case, a user instruction using the touch screen also can be handled as an input through the operation unit 205.

The display control unit 207 controls the display of a captured image or a character displayed on the display unit 206. The image capturing control unit 208 provides controls of the image capturing unit based on the instruction from the CPU 201, including focusing, shutter opening and closing, and diaphragm adjustment for example. The image capturing control unit 208 adjusts the control parameters of the image capturing unit based on the layout information of the image capturing apparatus. However, the details of the image capturing control unit 208 will be described later. A digital signal processing unit 209 subjects digital data received via the path 204 to various processings such as a white balance processing, a gamma processing, or a noise reduction processing.

An encoding unit 210 subjects the digital data to a processing to convert the data to have a file format such as JPEG or MPEG. An external memory control unit 211 functions as an interface to couple the image capturing apparatus 100 to a PC or other media (e.g., a hard disk, a memory card, a CF card, a SD card, a USB memory). The image processing unit 212 performs an image processing such as an image combination on a color image group acquired by the image capturing units 101 to 109 or a color image group outputted from the digital signal processing unit 209. The details of the image processing unit 212 will be described later. Components of the image capturing apparatus other than the above-described ones also exist. However, such components will not be described because these components are not the main contents of the present invention.

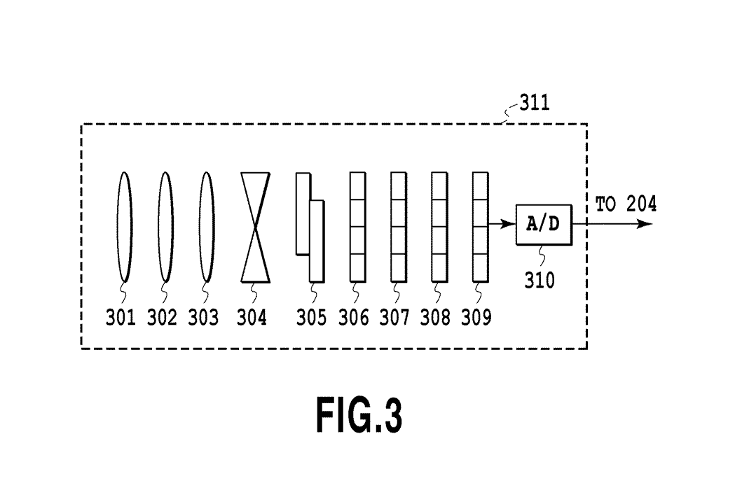

FIG. 3 illustrates the internal configuration of the image capturing units 101 to 109. The image capturing units 101 to 109 are composed of: lenses 301 to 303; a diaphragm 304; a shutter 305; an optical lowpass filter 306; an iR cut filter 307; a color filter 308; a sensor 309; and an A/D conversion unit 310. The lenses 301 to 303 are a zoom lens 301, a focus lens 302, and a blurr correction lens 303, respectively. The sensor 309 is a CMOS or CCD sensor for example that senses the light amount of an object focused by the above respective lenses. The sensed light amount is outputted as an analog value from the sensor 309 and is converted by the A/D conversion unit 310 to a digital value. Then, the resultant digital data is outputted to the bus 204.

### (Image Capturing Control Unit)

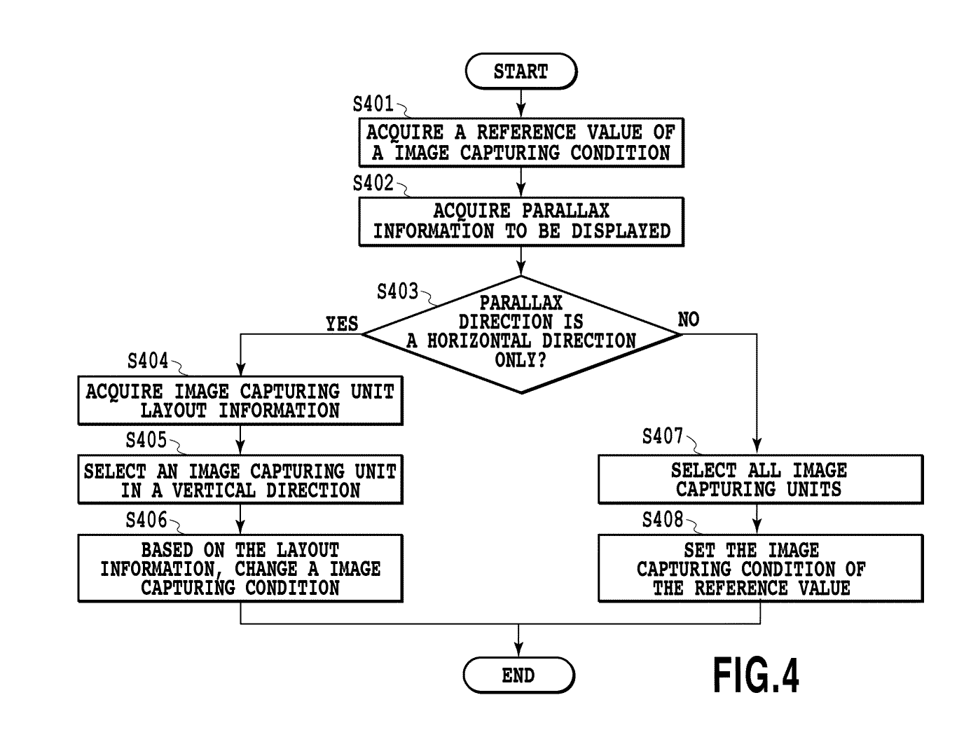

The following section will describe the details of the image capturing control unit 208. FIG. 4 is a flowchart illustrating the operation of the image capturing control unit 208. In this embodiment, in the case of a display method using lateral parallax (i.e., horizontal parallax) only, among image data acquired from the respective image capturing units, only the horizontal image data is subjected to a parallax-related processing. Specifically, in this case, in order to provide a stereoscopic display, since the calculation of the vertical parallax is not required, only the image data acquired from the image capturing units 104, 105, and 106 shown in FIG. 1 for example may be used for a processing to calculate a stereoscopic view display image without using the image data acquired from all of the image capturing units. Thus, although the respective image capturing units are generally controlled based on individually-set reference values, the image capturing units arranged in the vertical direction do not perform, in the case of a display method using a horizontal parallax only, a parallax-related processing in this embodiment.

First, Step S401 acquires a reference value for image capturing conditions. The image capturing conditions are parameters required to control the image capturing unit for an image capturing operation, including a shutter speed or an F number (diaphragm), and an ISO speed for example. The term “image capturing conditions” includes, in addition to the above parameters, the white balance setting, the existence or nonexistence of an ND filter, a focus distance, or a zoom setting for example. A part of the entirety of the reference values of the image capturing conditions can be set by a user through the operation unit 205 based on an instruction displayed on the display unit 206. The reference value may be set by programming, in addition to the above method, by a method to call a reference value recorded in the ROM 203 in advance or by being automatically set based on the surrounding environment during image capturing.

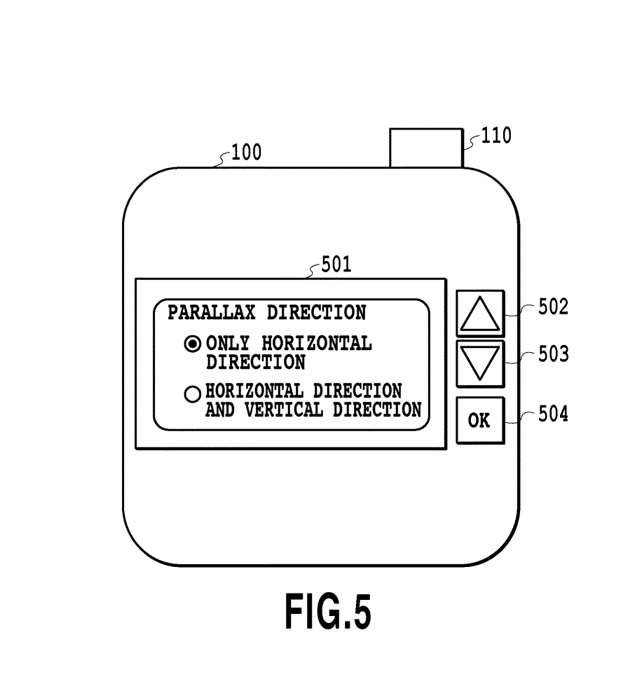

Step S402 acquires parallax-related information to be displayed. The parallax-related information to be displayed means information including the parallax of the display apparatus used for a stereoscopic operation. In this embodiment, the parallax-related information is specifically a horizontal parallax and a horizontal/vertical parallax. However, the present invention is not limited to this. The parallax-related information to be displayed can be set by a user through the operation unit 205 based on an instruction displayed on the display unit 206. FIG. 5 illustrates one example of a display unit for inputting the parallax-related information. In FIG. 5, the display unit 501 displays a GUI for setting a parallax direction. Through the display unit 501, any of the “horizontal direction” or the “horizontal direction” can be set by operating the operation units 502, 503, and 504. Another method also can be used to determine a parallax direction by selectively inputting or selecting a stereoscopic display apparatus. For example, when the parallax barrier method or the lenticular method is selected, the parallax direction is only the “horizontal direction”. When the lens array method or the CG method is selected, the parallax direction may be “a horizontal direction and a vertical direction”.

Step S403 determines whether the parallax direction is only the “horizontal direction” or not. When the parallax direction is only the “horizontal direction”, the processing proceeds to Step S404. When the parallax direction is not only the “horizontal direction”, the processing proceeds to Step S407. Step S404 acquires the layout information for the image capturing units. The layout information for the image capturing units is information showing the relative positional relation among all of the image capturing units. In this embodiment, the layout information for the image capturing units is recorded in the ROM 203 in advance. However, the layout information for the image capturing units also may be determined based on a user instruction if the image capturing apparatus can change the layout of the individual image capturing units based on the user instruction for example.

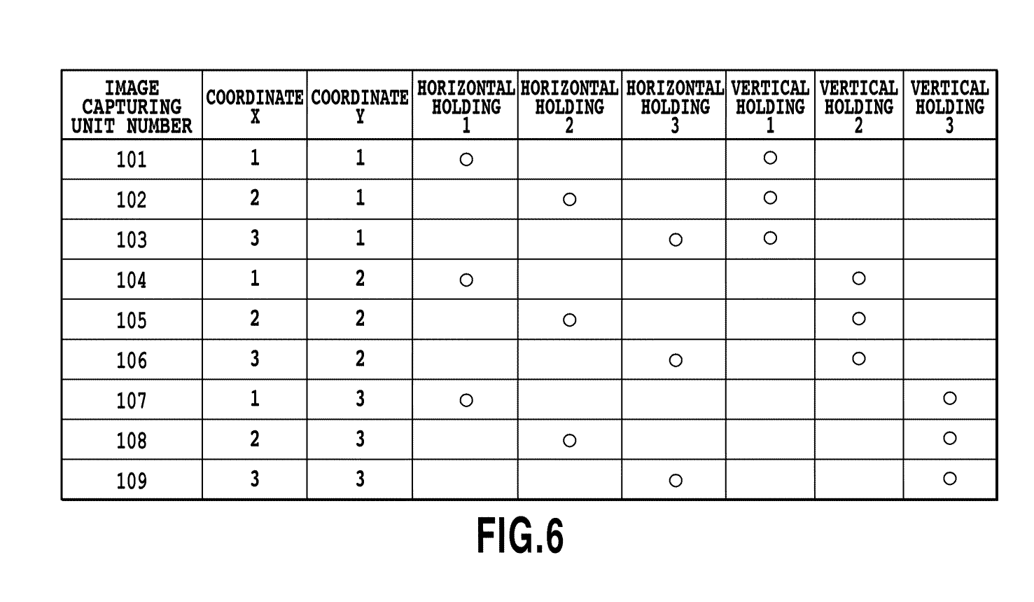

FIG. 6 illustrates one example of the layout information for the image capturing units. FIG. 6 records relative coordinate values for the individual image capturing units. For example, the coordinate X of the image capturing unit 101 is 1 and the coordinate Y is 1.

Step S405 selects an image capturing unit in the vertical direction. The image capturing unit in the vertical direction is a collection of image capturing units arranged in the vertical direction when the image capturing apparatus is held for an image capturing purpose. In this embodiment, the information for the image capturing unit in the vertical direction is also recorded in the ROM 203 together with the layout information. This information for the image capturing unit in the vertical direction is set in the layout information shown in FIG. 6. Specifically, an image capturing unit for which a horizontal holding 1 is shown with ◯ shows that the image capturing unit is included in the collection at a left end in the vertical direction when the image capturing apparatus is horizontally held (i.e., when the image capturing apparatus is horizontally held). With reference to FIG. 6, the left end collection (horizontal holding 1) is composed of the image capturing units 101, 104, and 107, the middle collection (horizontal holding 2) is composed of the image capturing units 102, 105, and 108. The right collection (horizontal holding 3) is composed of the image capturing units 103, 106, and 109.

When the image capturing apparatus is vertically held for an image capturing purpose on the other hand, the collection of the image capturing unit constituted in the vertical direction that is closest to the shutter 110 (vertical holding 1) is a combination of the image capturing units 101, 102, and 103. Similarly, the vertical holding 2 is a combination of the image capturing units 104, 105, and 106. The vertical holding 3 is a combination of the image capturing units 107, 108, and 109. How the image capturing apparatus is held may be determined by including a gravity sensor (not shown) in the image capturing apparatus. However, when a gravity sensor is not included in the image capturing apparatus, the vertical direction of the layout information may be assumed as the vertical direction.

Since the display method uses the horizontal parallax only, Step S406 changes the image capturing conditions based on the layout information. In this embodiment, based on the layout information, the exposure image capturing conditions are changed such as an exposure time (e.g., a shutter speed, an F number). Specifically, when the display method uses the horizontal parallax only as described above, the calculation of the vertical parallax is not required in order to provide a stereoscopic display. Thus, the image data acquired from the image capturing units arranged in the vertical direction is used for the processings other than a stereoscopic display. In this embodiment, selected image data is used to perform a high dynamic range (HDR) combination as described later, the image capturing units in the vertical direction are changes to have image capturing conditions suitable for this processing, respectively. For example, in the case of the image capturing units 101, 104, and 107 that is a combination for the horizontal holding 1, the image capturing units 101, 104, and 107 are set so as to be optimal for the high dynamic (HDR) combination, respectively. The change amount of the image capturing conditions based on the layout information may be determined by calling a set value stored in the ROM 203 in advance or by allowing a user to set the change amount through the operation unit 205.

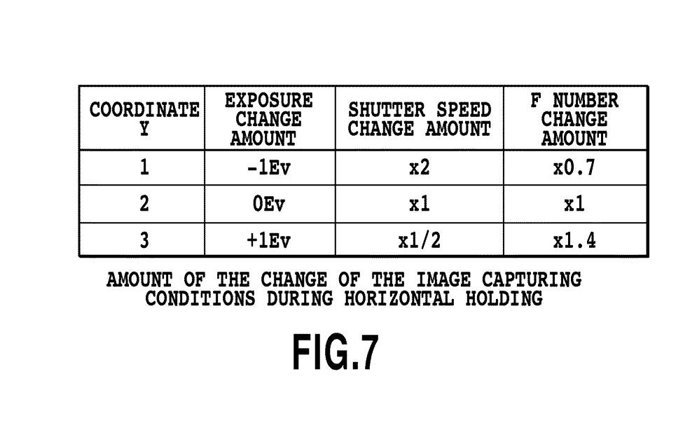

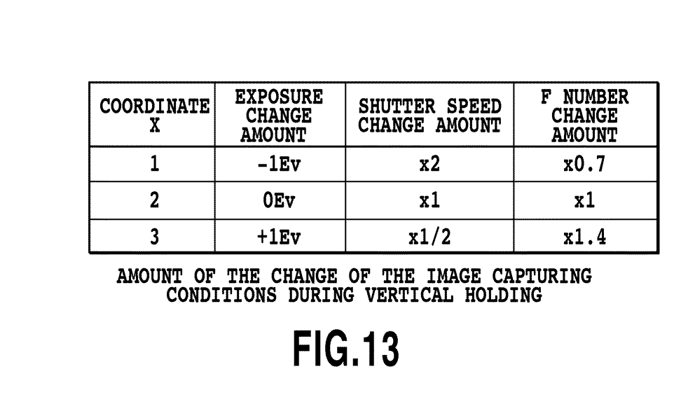

In this embodiment, the change amount of the image capturing conditions is recorded in the ROM 203 in advance, one example of which is shown in FIG. 7. In FIG. 7, the exposure change amount is determined based on the horizontal holding (i.e., the vertical coordinate value). For example, the image capturing units 101, 102, and 103 (coordinate Y of 1) are set so that the exposure is lowered to a level lower than the reference value by one level and are set so that the shutter speed is doubled the value F is multiplied by 0.7. The image capturing units 107, 108, and 109 (coordinate Y of 3) of the lower stage are set so that the exposure is higher by one level than the reference value and are set so that the shutter speed is halved or the value F is multiplied by 1.4. The exposure also may be changed by switching an ND filter for example in addition to the image capturing condition such as a shutter speed or a value F. When the vertical holding is used for an image capturing operation, the image capturing conditions may be changed as shown in FIG. 13.

Since the display method using a horizontal/vertical parallax, Step S407 requires the respective image capturing units to be individually set regardless of whether the vertical or horizontal direction is used. Thus, all of the image capturing units are selected. Next, Step S408 sets an image capturing condition having a reference value for all of the selected image capturing units. Specifically, when Step S403 determines that the parallax direction is not “the horizontal direction only”, the image capturing conditions for all of the image capturing units are set to a reference value because the image data from the respective image capturing units is thereafter used for the stereoscopic display processing.

### (Image Processing Unit)

Next, the following section will describe the details of the image processing unit 212. Generally, when a plurality of image data obtained by a multi-viewpoint image capturing apparatus are used to perform a stereoscopic image processing, a stereoscopic display is performed using the parallax between images regardless of a vertical or horizontal direction and layout information for the respective image capturing units. In this embodiment, in the case of a display method using only a horizontal parallax in particular, image data from the image capturing units arranged in a vertical direction is not used for a stereoscopic display processing and thus is effectively used for another image processing. In this embodiment, a high dynamic range (HDR) combination processing is carried out. However, the present invention is not limited to this. Thus, various processings can be used. In this embodiment, the stereoscopic display processing is carried out using the processing of images from image capturing units arranged in the vertical direction. Specifically, in this embodiment, the stereoscopic display processing is carried out using the horizontal image data obtained after the HDR combination processing. However, the invention is limited to this. Thus, the stereoscopic display processing can be carried out at an arbitrary timing and arbitrary image data. Although not described in detail here, the stereoscopic display processing can be performed using any method known in the field. For example, the stereoscopic display can be carried out by calculating the distance from the parallax between any two images in the horizontal direction to the object by the respective pixels.

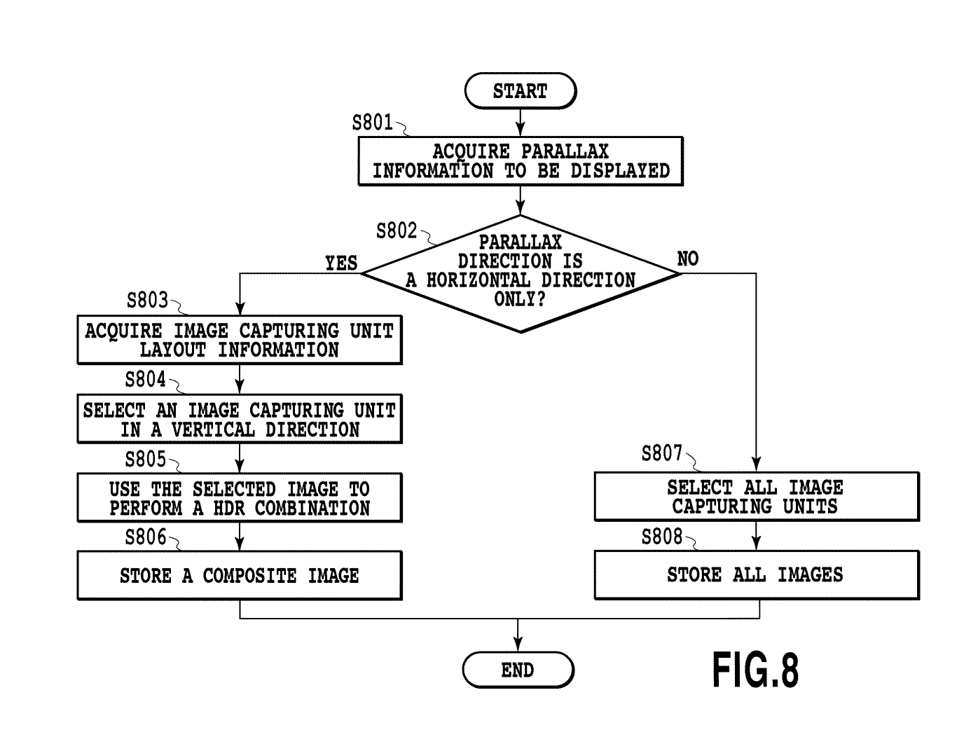

FIG. 8 is a flowchart illustrating the operation of the image processing unit 212. First, Step S801 acquires parallax-related information to be displayed. The parallax-related information to be displayed is the same as that in Step S402 and thus will be not described further. Next, Step S802 determines, based on the parallax-related information, whether the parallax direction is only the “horizontal direction” or not. When the parallax direction is only the “horizontal direction”, the processing proceeds to Step S803. When the parallax direction is not only the “horizontal direction”, the processing proceeds to Step S807. Step S803 acquires the layout information for the image capturing units. The layout information for the image capturing units is the same as that in Step S404 and thus will be not described further. Next, Step S804 selects the image capturing unit in the vertical direction. The image capturing unit in the vertical direction is the same as that in Step S405 and thus will be not described further. Next, Step S805 uses the selected image to perform the high dynamic range (HDR) combination. The selected images are the three images acquired from the image capturing units 101, 104, and 107, respectively, the three images acquired from the image capturing units 102, 105, and 108, respectively, and the three images acquired from the image capturing units 103, 106, and 109, respectively. Specifically, the selected images of the respective three images are subjected to three HDR combination processings in this embodiment.

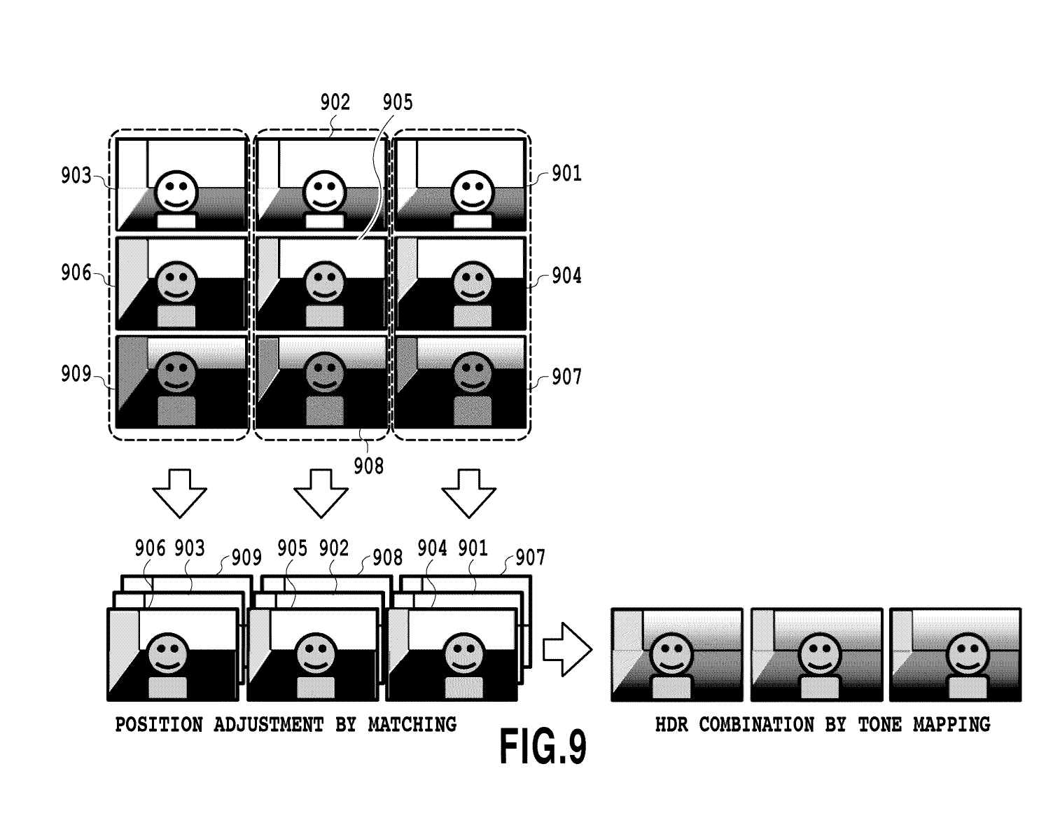

FIG. 9 is a conceptual diagram illustrating the HDR combination processing. The images 901 to 909 shown in FIG. 9 are images acquired by the image capturing units 101 to 109, respectively and have different exposure image capturing conditions, respectively. In this embodiment, the selected images are subjected to position adjustment. The selected images are subjected to the position adjustment by a generally-known method using pattern matching or block matching. However, any method known in the field also can be used. In this embodiment, since image data to be subjected to position adjustment is acquired from the image capturing unit in the vertical direction, a higher processing can be achieved by limiting the matching search direction to a vertical direction. Next, the selected image subjected to the position adjustment is used to perform the HDR combination processing. The HDR combination processing may be performed by a generally-known method using tone mapping. However, another method also can be used. The tone mapping is a technique to extract not-broken gradation regions from pieces of image data having different exposures to superpose the regions. However, the details thereof will not be described later.

Step S806 stores a composite image. In this embodiment, three composite images are stored that reflect the number of the combinations image capturing units constituted in the vertical direction. Specifically, the three composite images are stored that are combined of: a composite image obtained by combining the images 901, 904, and 907; a composite image obtained by combining the images 902, 905, and 908; and a composite image obtained by combining the images 903, 906, and 909. The composite images are also stored in PC and other media 213 through the RAM 202 or the external memory control unit 211. Not only the composite image but also images not yet combined also may be stored.

Since the horizontal/vertical parallax display method is used, Step S807 does not perform any processings other than the stereoscopic display (e.g., the HDR combination processing) because the images 901 to 909 are all used for the stereoscopic display. Thus, all of the image capturing units are used as image data used for the stereoscopic display. Next, Step S808 stores all of the image.

Finally, when Step S802 determines that the parallax direction is not only the “horizontal direction”, the images of all of the image capturing units are stored as in the conventional technique. When Step S802 determines that the parallax direction is only the “horizontal direction”, on the other hand, such image processing result is used that is obtained by performing an image processing on the images of all of the image capturing units existing in the vertical direction.

By the procedure as described above, a multi-viewpoint image having a wide dynamic range can be acquired by using information of an image capturing apparatus nor used for a stereoscopic view. For a stereoscopic display processing, an appropriate image may be selected from among the stored multi-viewpoint images in accordance with the display method used by the display apparatus. For example, in the case of a display method using parallax of two images (images for right and left eyes respectively), an image 906 for the left eye or the composite image thereof and an image 904 for the right eye or the composite image thereof may be selected. A selected image may be changed depending on the display apparatus or the magnitude of the parallax of the viewer.

In this embodiment, the configurations of the respective parts and the processings have been described based on an assumption that images imaged by the image capturing units 101 to 109 are all color images. However, a part of the entirety of the images imaged by the image capturing units 101 to 109 also may be changed to a monochrome image. In this case, the color filter 308 of FIG. 3 is omitted.

### Embodiment 2

Embodiment 1 has been described with regard to a method of acquiring a multi-viewpoint image having a wide dynamic range by changing the exposure of the image capturing apparatus in the vertical direction. In this embodiment, such a method will be described that subjects, image data acquired by image capturing units arranged in the vertical direction, to processings other than the stereoscopic display so as to acquire a multi-viewpoint image having reduced noise, even when the ISO speed value of the image capturing apparatus is changed to a higher value.

In this embodiment, a part of the operations of the image capturing control unit 208 and the image processing unit 212 is different from those of Embodiment 1 but the other processings are the same as those of Embodiment 1 and thus will not be described later.

### (Image Capturing Control Unit)

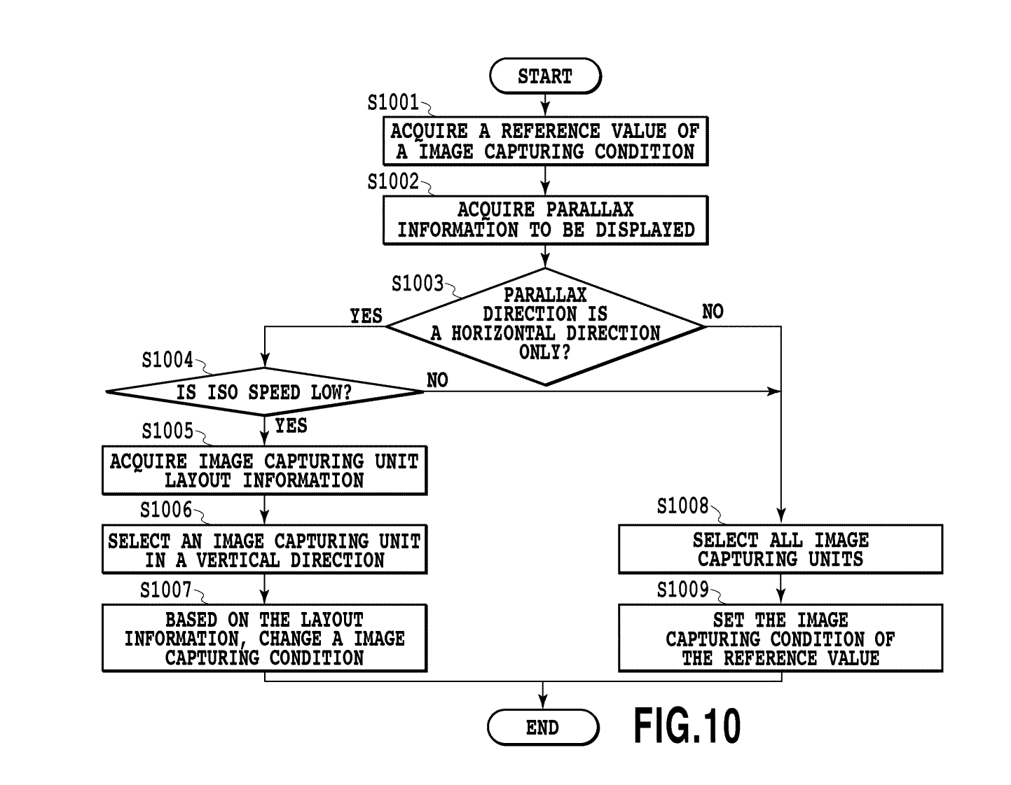

The following section will describe the details of the image capturing control unit 208. FIG. 10 is a flowchart illustrating the operation of the image capturing control unit 208. First, Step S1001 acquires a reference value for an image capturing condition. The reference value of the image capturing condition is the same as that of Step S401 of Embodiment 1 and thus will not be described later.

Step S1002 acquires the parallax-related information to be displayed. The parallax-related information to be displayed is the same as that of Step S402 of Embodiment 1 and thus will not be described later. Next, Step S1003 determines whether the parallax direction is “only the horizontal direction” or not. When the parallax direction is “only the horizontal direction”, the processing proceeds to Step S1004. When the parallax direction is not “only the horizontal direction”, the processing proceeds to Step S1008.

Step S1004 determines whether the ISO speed is low or not. When the ISO speed is low, the processing proceeds to Step S1005. When the ISO speed is not low, the processing proceeds to Step S1008. The ISO speed constitutes a part of the image capturing conditions acquired in Step S1001 and shows a value reflecting the sensitivity of the imaging sensor. Generally, the lower the ISO speed is, a higher amount of light is required but noise is reduced. On the other hand, the higher the ISO speed is, an image capturing operation can be performed even with a small amount of light but increased noise tends to occur. In this embodiment, whether the set ISO speed is high or low is determined based on the comparison between the ISO speed and a value recorded in advance in the ROM 203 (e.g., 800). Thus, when the ISO speed is set to 400, the HDR combination processing of Embodiment 1 is performed so that an image having a wide dynamic range can be obtained even when the ISO speed is low. When the ISO speed has a value higher than 800 on the other hand, a noise reduction processing is carried out to thereby reduce noise.

Step S1005 acquires the layout information for the image capturing units. The layout information for the image capturing units is the same as that of Step S404 of Embodiment 1 and thus will not be described later. Next, Step S1006 acquires the image capturing unit in the vertical direction. The image capturing unit in the vertical direction is the same as that of Step S405 of Embodiment 1 and thus will not be described later. Next, Step S1007 changes the image capturing condition based on the layout information. The change of the image capturing condition is the same as that in Step S406 of Embodiment 1 and thus will not be described later.

Step S1008 selects all image capturing units as in S407 of FIG. 8. Next, Step S1009 sets, with regards to all of the selected image capturing units, a image capturing condition having a reference value. Specifically, the set ISO speed is used even when the ISO speed is high.

By the procedure as described above, the image capturing control unit 208 in this embodiment fails to perform, when the ISO speed is high, the HDR processing even when the parallax direction is “only the horizontal direction”. Thus, all of the image capturing units have the same image capturing conditions. Specifically, since a high ISO speed includes a high amount of noise, an image processing unit (which will be described later) prioritizes the noise reduction processing. However, whether the noise reduction processing is prioritized or not also may be determined based on a user instruction.

### (Image Processing Unit)

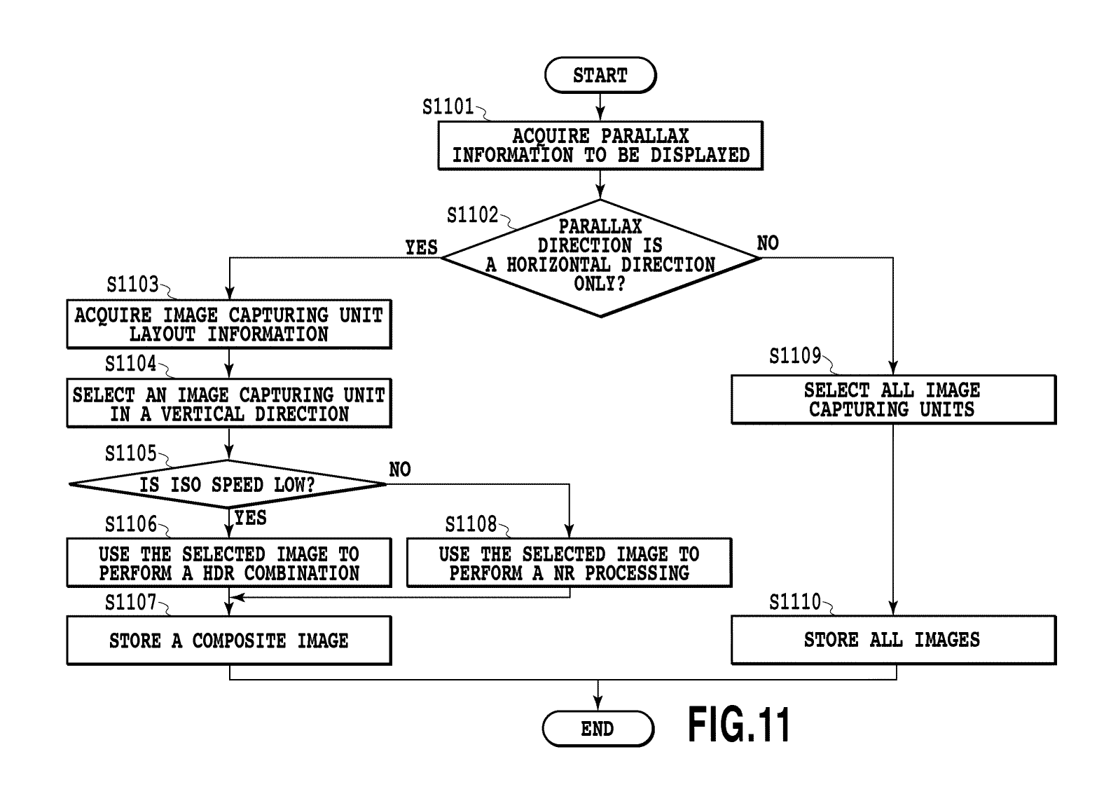

The following section will describe the details of the image processing unit 212 with reference to FIG. 11. FIG. 11 is a flowchart illustrating the operation of the image processing unit 212. First, Step S1101 acquires the parallax-related information to be displayed. The parallax-related information to be displayed is the same as Step S801 of Embodiment 1 and thus will not be described later. Next, Step S1102 determines whether the parallax direction is “only the horizontal direction” or not. When the parallax direction is “only the horizontal direction”, the processing proceeds to Step S1103. When the parallax direction is not “only the horizontal direction”, the processing proceeds to Step S1109.

Step S1103 acquires the layout information for the image capturing units. The layout information for the image capturing units is the same as that of Step S803 of Embodiment 1 and thus will not be described later. Next, Step S1104 selects the image capturing unit in the vertical direction. The image capturing unit in the vertical direction is the same as that of Step S804 of Embodiment 1 and thus will not be described later. Next, Step S1105 determines whether the ISO speed is low or not. When the ISO speed is low, the processing proceeds to Step S1106. When the ISO speed is not low, the processing proceeds to Step S1107.

Step S1106 uses the selected image to perform the HDR combination. The HDR combination is the same as Step S805 of Embodiment 1 and thus will not be described later. Next, Step S1107 stores the composite image. The storage of the composite image is the same as that in Step S806 of Embodiment 1 and thus will not be described later.

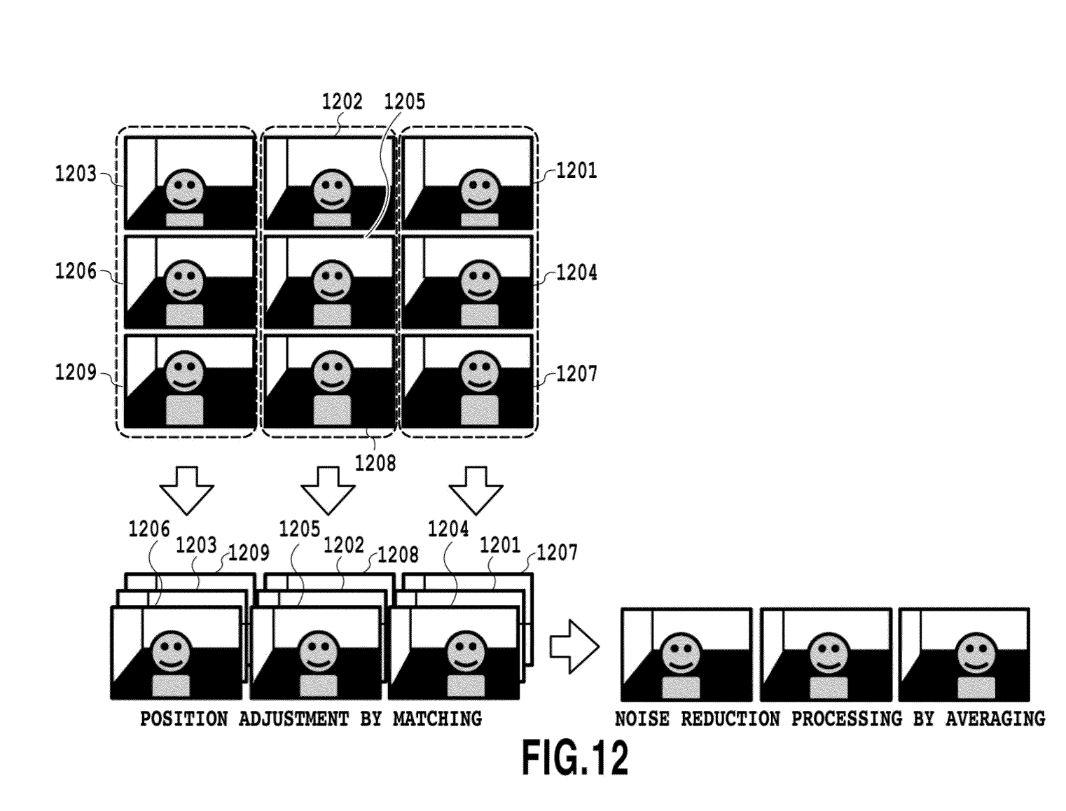

Since the ISO speed is high, Step S1108 uses the selected image to perform the noise reduction (NR) processing. FIG. 12 is a conceptual diagram illustrating the NR processing. The images 1201 to 1209 shown in FIG. 12 are image data acquired by the image capturing units 101 to 109, respectively and are photographed at a high ISO speed. In this embodiment, as in Embodiment 1, the selected image is firstly subjected to a position adjustment. Next, the image data subjected to the position adjustment is used to perform the NR processing. The NR processing is generally performed by a filter processing using a lowpass filter for example. However, such a filter processing has a disadvantage of a blurred edge for example. To prevent this, in this embodiment, the NR processing is performed by averaging the image data subjected to the position adjustment. However, the invention is not limited to this. Thus, any method known in the field also may be used. After the completion of the NR processing, the processing proceeds to Step S1107 to store the processed image.

Step S1109 selects all of the image capturing units. Next, Step S1110 stores all of the images. The image storage is the same as that of Step S808 of Embodiment 1 and thus will not be described later.

By the procedure as described above, the image processing unit 212 performs, when the parallax direction is “only the horizontal direction” and the ISO speed is high, noise reduction processings other than the stereoscopic display on the image data acquired by the image capturing units arranged in the vertical direction. Thus, a processing optimal for the ISO speed can be carried out.

By the procedure as described above, information for the image capturing apparatus not used for the stereoscopic view can be used to acquire a multi-viewpoint image having a reduced amount of noise.

In this embodiment, the noise reduction processing has been described. However, a super resolution processing also may be performed that uses the image data subjected to the position adjustment to thereby improve the resolution. In this embodiment, the change of the image capturing conditions (e.g., the exposure, the ISO speed) based on the layout information has been described. However, the invention is not limited to this. For example, an image capturing condition such as a color filter or a focus position also may be changed.

### Embodiment 3

In Embodiment 1, a method has been described to acquire a multi-viewpoint image having a wide dynamic range by changing the exposure of the image capturing apparatus in the vertical direction. With regards to the processing to generate a stereoscopic display image, a method has been described to select, from among acquired multi-viewpoint images, an appropriate image depending on the display method of the display apparatus. In this embodiment, such a method will be described that generates an image from a virtual point of view obtained by interpolating the multi-viewpoint image depending on the characteristic of the display apparatus, the positional relation with the viewer, or the magnitude of the parallax of the viewer. A method also will be described that calculates the distance map from the image capturing apparatus in the v to the object to use the distance map to thereby perform a HDR combination processing and a stereoscopic display processing. This can consequently reduce the processing time when compared with the HDR combination processing or the stereoscopic display processing known in the field.

In this embodiment, a part of the operation of the image processing unit 212 is different from that of Embodiment 1. However, the other processings are the same as those of Embodiment 1 and thus will not be described later.

### (Image Processing Unit)

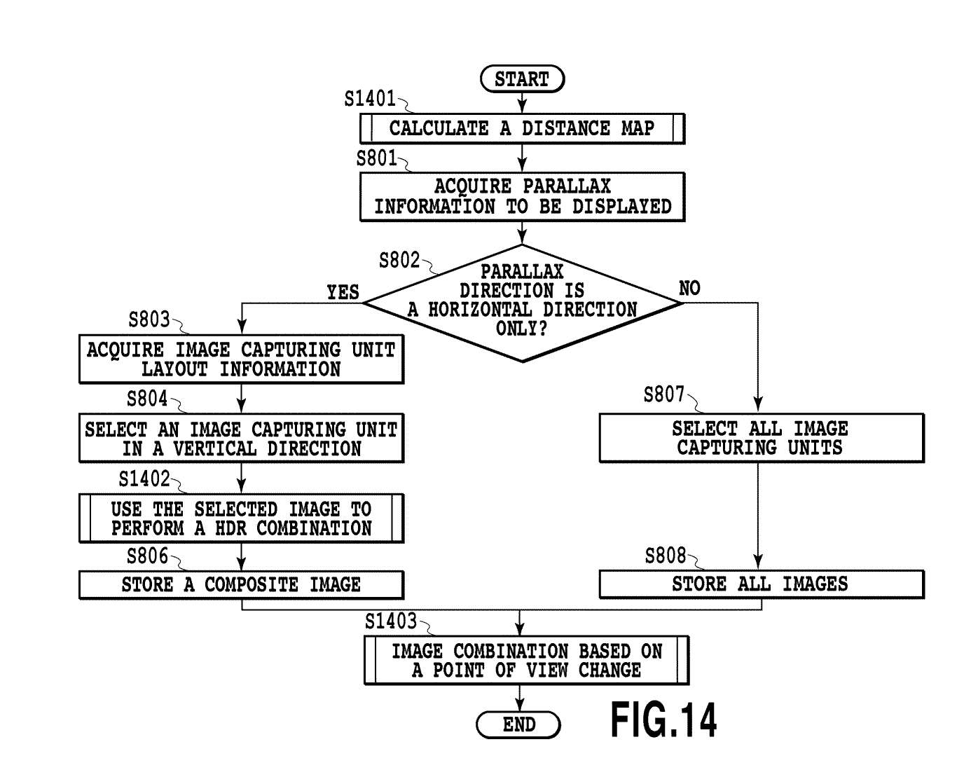

The following section will describe the image processing unit 212 in detail. FIG. 14 is a flowchart illustrating the operation of the image processing unit 212. Those steps having the same processing details as those of the flowchart for the image processing unit shown in FIG. 8 in Embodiment 1 will be denoted with the same reference numerals will not be described later.

Step S1401 uses photographed image data to calculate a distance map. The distance map is two-dimensional information in image data including a distance to the object and is a so-called depth map. The details of the distance map calculation will be described later. Step S1402 uses the calculated distance map to perform the HDR combination processing. The image position adjustment in the HDR combination processing is performed using the distance map calculated in Step S1401. The details of the HDR combination processing will be described later.

Step S1403 uses the calculated distance map to combine the image having a desired parallax for which the position of the point of view is changed. The parallax interpolating processing in the processing for changing a point of view is performed using the distance map calculated in Step S1401. The details of the processing for changing a point of view will be described later. Specifically, in this embodiment, the distance map calculated in advance is used for both of the HDR combination processing and the processing for changing a point of view so that a common calculation for the image position adjustment is achieved. This can consequently reduce the processing time when compared with the conventional processing known in the field.

### (Distance Map Calculation Processing)

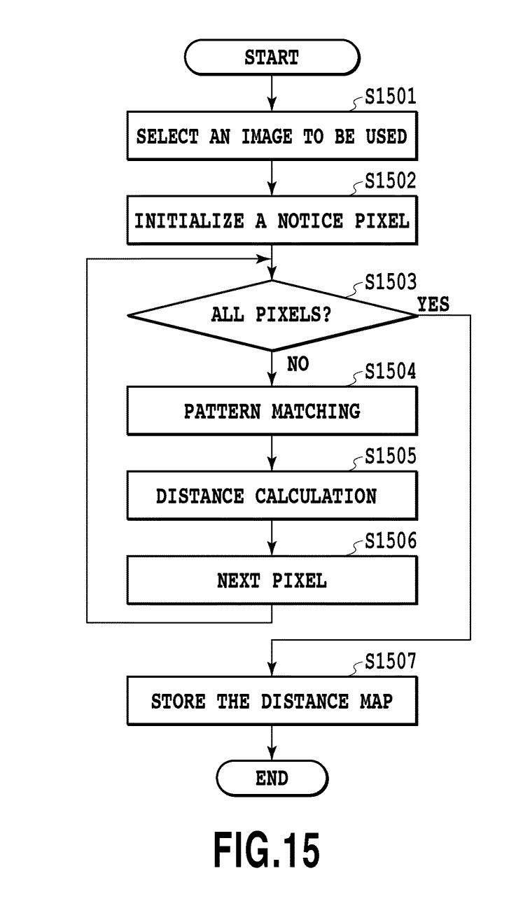

The following section will describe the details of the distance map calculation processing performed in Step S1401 of the flowchart shown in FIG. 14. In the distance map calculation processing, a distance of an imaged scene is estimated based on a plurality of captured images having different positions to thereby calculate a distance map. This distance map calculation processing may be performed by a known method, including, for example, the stereo method or the multi-baseline stereo method. In this embodiment, the distance map is calculated by the stereo method. The following section will describe, with reference to the flowchart shown in FIG. 15, the details of the distance map calculation processing.

First, Step S1501 selects image data used to calculate the distance map. In this embodiment, the image data imaged by the image capturing unit 105 arranged at the center of the image capturing apparatus 100 and the image data imaged by the image capturing unit 104 adjacent thereto in the horizontal direction are selected. In the following description, the former is called a reference image and the latter is called a subject image. Selected image data is not limited to this. Any image data may be used that correspond to two images having different positions.

Step S1502 initializes a notice pixel to be subjected to the subsequent processing. Step S1503 determines whether the distance information is calculated for all pixels or not. When the distance information is calculated for all pixels, the processing proceeds to Step S1507. When the distance information is not calculated for all pixels, the processing proceeds to Step S1504. Step S1504 selects such a region that consists of the notice pixel of the reference image and the surrounding pixels. Then, a block as a selected region is used to perform a pattern matching between this region and the subject image to thereby calculate a pixel corresponding to the notice pixel from among the subject image (corresponding pixel).

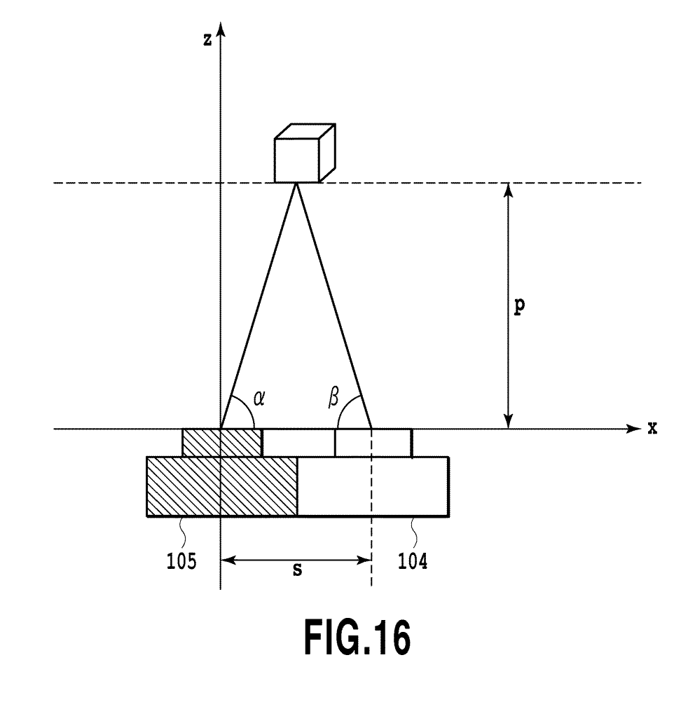

Step S1505 calculates the distance information p based on the layout information for the image capturing apparatus and the notice pixel and the surrounding corresponding pixels. The distance information p is represented by α, β, and s shown in FIG. 16.

$$p = \frac{sin α sin β}{sin ( π - α - β )} s$$

In the formula, α is calculated based on the horizontal field angle of the image capturing apparatus 105, the imaging position of the reference image, and the coordinate of the notice pixel. β is calculated based on the horizontal field angle of the image capturing unit 104, the imaging position of the subject image, and the coordinate of the corresponding pixel. s is the horizontal distance between the image capturing units and is calculated based on the reference image and the imaging position of the subject image.

Step S1506 updates the notice pixel. Then, the processing returns to Step S1503. Step S1507 stores the distance map using the respective pixel values as the distance information of the reference image.

### (HDR Combination Processing)

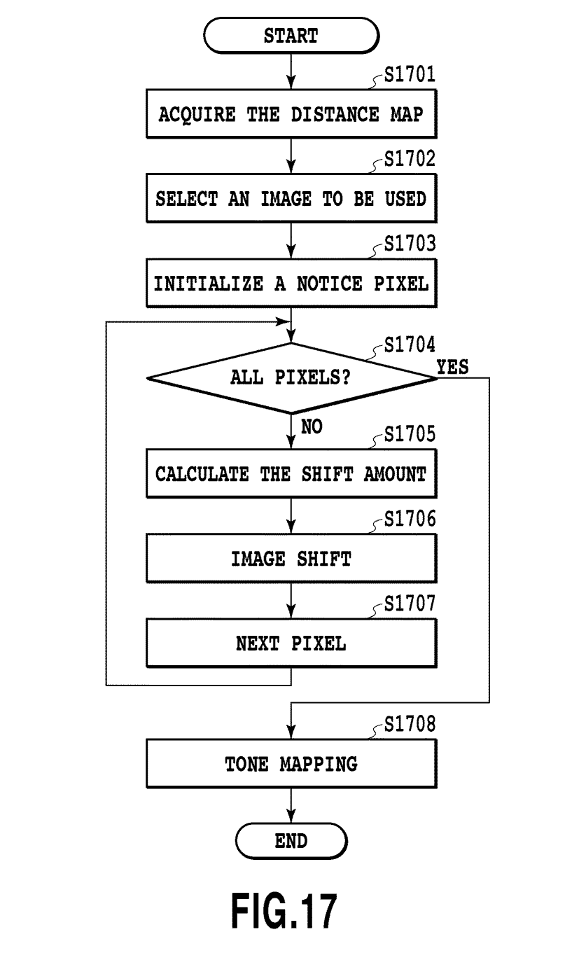

The following section will describe the details of the HDR combination processing performed in Step S1402 of the flowchart shown in FIG. 14. In the HDR combination processing, the image position adjustment is performed using the distance map and the HDR combination is performed based on tone mapping. The following section will describe the details of the HDR combination processing with reference to the flowchart shown in FIG. 17.

First, Step, S1701 acquires the distance map calculated in Step S1501. Step S1702 selects the image data used for the HDR combination. The image data is selected from among the image data selected in Step S804 (i.e., the image data acquired from the image capturing unit arranged in the vertical direction). In this embodiment, the image data imaged by the image capturing unit 105 arranged at the center of the image capturing apparatus 100 and the image data imaged by the image capturing unit 102 adjacent thereto in the vertical direction are selected. In the following description, the former is called a reference image and the latter is called a subject image. Selected image data is not limited to this. Any image data may be used that correspond to two or more images imaged by the image capturing units arranged at different positions in the vertical direction.

Step S1703 initializes a notice pixel as a subject to be subjected to the subsequent processing. Step S1704 determines whether an image shift is performed on all pixels or not. When an image shift is performed on all pixels, the processing proceeds to Step S1708. When an image shift is not performed on all pixels, the processing proceeds Step S1705.

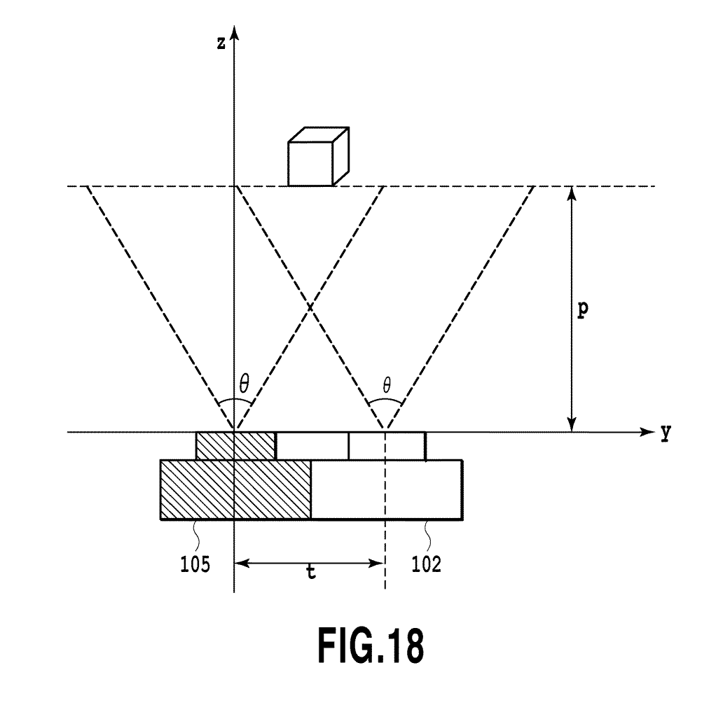

Step S1705 calculates the shift amount in the image position adjustment. The image position adjustment is a processing to adjust the position of the object in the subject image in accordance with the position of the object of in the corresponding reference image. The shift amount shows the number of pixels moved when the position adjustment is performed to move the notice pixel of the subject image to the corresponding pixel in the reference image. The shift amount m is represented by the following formula using p, t, and θ shown in FIG. 18.

$$m = \frac{t}{2 p tan ( θ / 2 )} H$$

In the formula, p shows the distance information of the notice pixel and is acquired based on the distance map. t shows the vertical distance between image capturing units. θ is a vertical view angle of the image capturing unit. H shows the number of pixels of the image data in the vertical direction.

Step S1706 moves the notice pixel based on the calculated shift amount. Step S1707 updates the notice pixel. Then, the processing returns to Step S1704. Step S1708 performs the image combination by tone mapping on the subject image subjected to the position adjustment by the image shift and the reference image. The tone mapping is a technique to extract not-broken gradation regions from pieces of image data having different exposures to superpose the regions. However, the details thereof will not be described later.

### (Processing for Changing a Point of View)

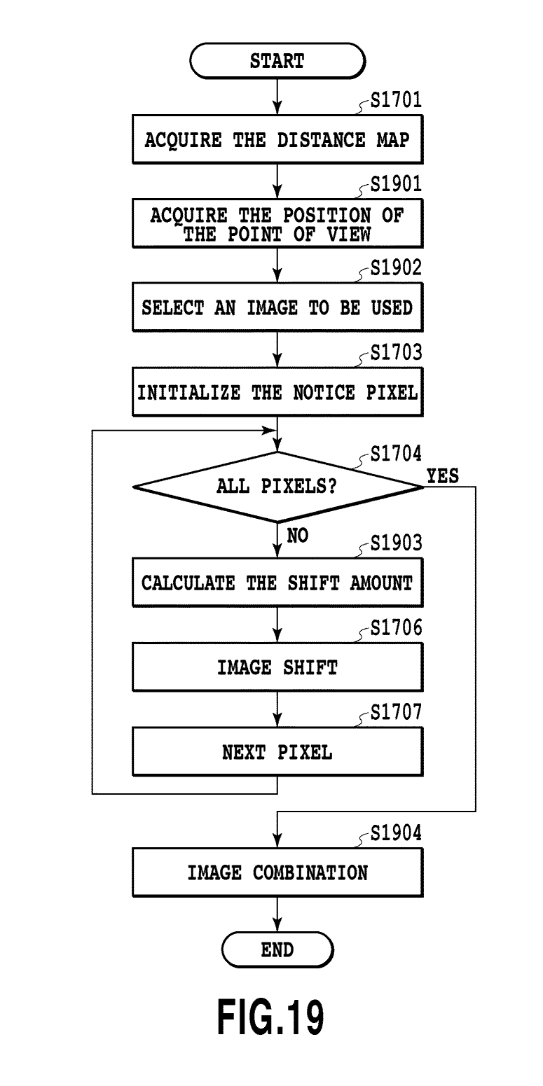

The following section will describe the details of the processing to change the position of the point of view performed in Step 1403 of the flowchart shown in FIG. 14. The processing for changing the point of view uses the distance map to calculate the image shift amount to the position of the point of view to combine the image for which the position of the point of view is changed. The following section will describe, with reference to the flowchart shown in FIG. 19, the details of the processing for changing a point of view. Those steps having the same processing details as those of the flowchart for the HDR combination processing shown in FIG. 17 will be denoted with the same reference numerals will not be described later.

Step S1901 acquires the information for the position of the point of view to be subjected to an image combination. The information for the position of the point of view shows the position of the virtual image capturing unit when the image capturing unit exists at the position of the point of view and can be set within a range to which the image capturing units 101 to 109 of the image capturing apparatus 100 are interpolated. The information for the position of the point of view is appropriately set depending on the display format of the display apparatus. For example, in the case of the display apparatus having a lenticular display format having five disparities in the horizontal direction, the position of the point of view of the virtual image capturing unit can be set to a position at an intermediate position between the image capturing unit 104 and the image capturing unit 105 and a position at an intermediate position between the image capturing unit 105 and the image capturing unit 106. As described above, the information for the position of the point of view can be set to an appropriate value depending on the characteristic or system of the display apparatus and can be set to desired information depending on the viewer based on the information for the viewer or an instruction from the viewer. In this embodiment, the following section will describe a case where the position of the point of view of the virtual image capturing unit is at an intermediate position between the image capturing unit 104 and the image capturing unit 105.

Step S1902 selects the image data to be used in the image combination based on the change of the point of view. In this embodiment, based on the information for the position of the point of view, the image data imaged by the image capturing unit 105 and the image data imaged by the image capturing unit 104 are selected.

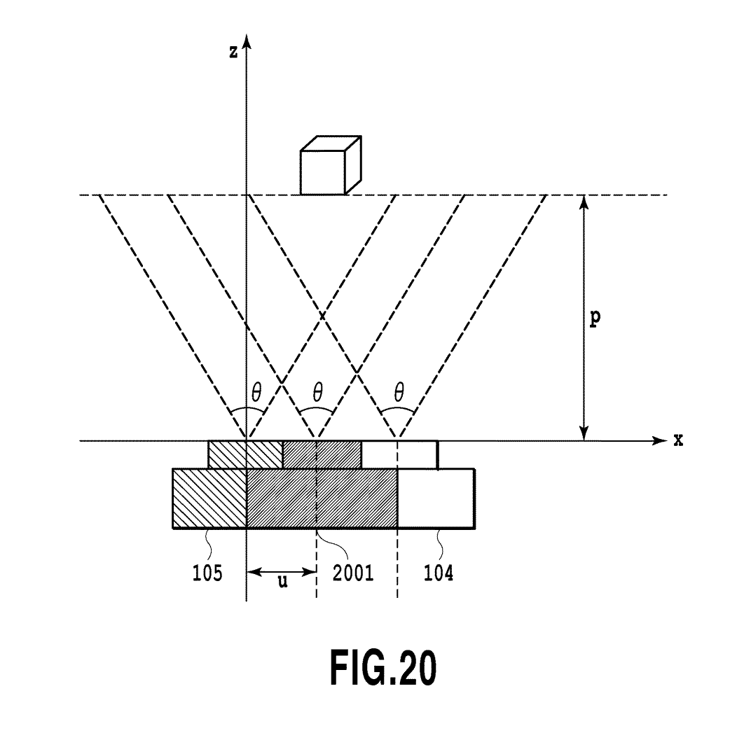

Step S1903 calculates the shift amount in order to change the position of the point of view of the subject image to the position of the point of view acquired in Step S1901. The shift amount n is represented by the following formula using p, u, and θ shown in FIG. 20.

$$n = \frac{u}{2 p tan ( θ / 2 )} W$$

In the formula, p is the distance information for the notice pixel and is acquired from the distance map. u is a horizontal distance from the position of the point of view of the subject image to the position of the point of view to be subjected to an image combination. Θ is a horizontal view angle of the image capturing unit. W is the number of pixels of the image data in the horizontal direction. Step S1904 superposes all of the subject images subjected to an image shift to subject the images to an image combination. In this embodiment, a method has been described to calculate the processing for changing the position of the point of view based on the image shift. However, the invention is not limited to this. For example, feature points extracted from two or more images may be associated to one another and a morphing processing may be performed based on the correspondence among the respective feature points to thereby perform the processing for changing the position of the point of view.

By the procedure as described above, the HDR image can be generated at the HDR image interpolated from the multi-viewpoint image depending on the characteristic of the display apparatus, the positional relation with the viewer, or the magnitude of the parallax of the viewer. Furthermore, the processing time can be reduced by calculating the distance map from the image capturing apparatus in the horizontal direction to the object to use the distance map to perform the HDR combination processing and the stereoscopic display processing.

In this embodiment, a method has been described to use the distance map to perform the HDR combination processing and the stereoscopic display processing. However, the processing using the distance map is not limited to this. For example, the invention also can be applied to the NR processing in Embodiment 2.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-219388 filed Oct. 3, 2011 and 2012-160689 filed Jul. 19, 2012 which are hereby incorporated by reference herein in its entirety.

What is claimed is:

1. An image processing apparatus for generating parallax image data representing a plurality of parallax images having parallax in a first direction, comprising:
an input unit configured to receive a plurality of input image data acquired by a plurality of image capturing units arranged on a lattice consisting of the first direction and a second direction different from the first direction; and
a generation unit configured to combine, with regard to each column of the second direction, a plurality of input image data obtained by an image capturing unit corresponding to the column to thereby generate parallax image data representing a plurality of parallax images having parallax in the first direction.

2. A camera having a plurality of image capturing units arranged on a lattice consisting of a first direction and a second direction different from the first direction, wherein: a plurality of input image data obtained by an image capturing unit corresponding to the column is combined for the second column each to thereby generate parallax image data representing a plurality of parallax images having parallax in the first direction.

3. The image processing apparatus according to claim 1, further comprising:
a direction determination unit configured to determine the first direction and the second direction.

4. The camera according to claim 2, wherein:
the direction determination unit determines the first direction and the second direction based on a direction of an image capturing apparatus having the plurality of image capturing units to a gravity direction.

5. The image processing apparatus according to claim 1, wherein:
a plurality of input image data combined for each column of the second direction are acquired by an image capturing based on a different exposure condition depending on the plurality of image capturing units,
the generation unit combines the plurality of input image data to thereby generate parallax image data having a wide dynamic range.

6. The image processing apparatus according to claim 1, wherein:
the generation unit combines the plurality of input image data to thereby generate parallax image data for which noise is reduced.

7. An image processing apparatus for generating parallax image data representing a plurality of parallax images having parallax in a first direction, comprising:
an input unit configured to receive a plurality of input image data acquired by a plurality of image capturing units arranged on a lattice consisting of the first direction and a second direction different from the first direction; and
a generation unit configured to combine, with regard to each column of the second direction, a plurality of input image data obtained by an image capturing unit corresponding to the column to thereby generate parallax image data representing a plurality of parallax images having parallax in the first direction,
wherein the first direction and the second direction are determined based on a direction of an image capturing apparatus having the plurality of image capturing units to a gravity direction.

8. An image processing method for generating parallax image data representing a plurality of parallax images having parallax in a first direction, comprising the steps of:
inputting a plurality of input image data acquired by a plurality of image capturing units arranged on a lattice consisting of the first direction and a second direction different from the first direction; and
combining, with regard to each column of the second direction, a plurality of input image data obtained by an image capturing unit corresponding to the column to thereby generate parallax image data representing a plurality of parallax images having parallax in the first direction.

9. A program stored in a non-transitory computer readable storage medium for causing a computer to perform the image processing method according to claim 8.
